(19) United States
(12) Patent Application Publication
(10) Pub. No.: US 2007/0206233 A1
(43) Pub. Date: Sep. 6, 2007

(54) Image processing apparatus and computer readable medium storing image processing program

(75) Inventors: Toshiya Koyama, Kanagawa (JP); Hideaki Ashikaga, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/517,288

(22) Filed: Sep. 8, 2006

(30) Foreign Application Priority Data
Mar. 6, 2006 (JP) 2006-058998

(51) Int. Cl. H04N 1/40

(52) U.S. Cl. 358/462

(57) ABSTRACT

An image processing apparatus includes: a first positioning part that performs positioning between a first original image and a second original image which is obtained after execution of additional entry, with respect to an entire original; a first extraction part that extracts difference information between the first original image and the second original image subjected to the positioning by the first positioning part; a second positioning part that locally performs positioning between the first original image and the second original image based on the difference information extracted by the first extraction part; and a second extraction part that extracts additional entry information from the second original image between the first original image and the second original image subjected to the positioning by the second positioning part.

### BACKGROUND

1. Technical Field

The present invention relates to an image processing apparatus and a computer readable medium storing an image processing program, and more particularly, to an image processing apparatus and a computer readable medium storing an image processing program for comparing an original image before additional entry with the original image after the additional entry so as to extract an additional entry portion (additional entry information).

2. Related Art

In the field of image processing, there are needs for extracting and utilizing a hand-written entry-added portion or a sealed portion (hereinbelow, these portions will be referred to as an “additional entry area”) from a paper original where a hand-write additional entry (revision) or seal impression has been made. Hereinbelow, a paper original before execution of hand-write additional entry or seal impression will be referred to as an entry-unadded original, and a paper original after the execution of hand-write additional entry or seal impression will be referred to as an entry-added original.

### SUMMARY

According to an aspect of the invention, there is provided an image processing apparatus including: a first positioning part that performs positioning between a first original image and a second original image which is obtained after execution of additional entry, with respect to an entire original; a first extraction part that extracts difference information between the first original image and the second original image subjected to the positioning by the first positioning part; a second positioning part that locally performs positioning between the first original image and the second original image based on the difference information extracted by the first extraction part; and a second extraction part that extracts additional entry information from the second original image between the first original image and the second original image subjected to the positioning by the second positioning part.

### BRIEF DESCRIPTION OF THE DRAWINGS

An exemplary embodiment of the present invention will be described in detail based on the following figures, wherein:

FIG. 1 schematically illustrates the system configuration of an image processing system to which the present invention is applied;

FIG. 2 is a block diagram showing a more particular configuration of the image processing system including an image processing apparatus according to the present invention;

FIG. 3 is a block diagram showing the functional construction of the image processing apparatus according to an exemplary embodiment of the present invention;

FIG. 4 illustrates a first example of position/skew correction processing;

FIG. 5 is a flowchart showing an example of additional entry information extraction processing;

FIGS. 6A to 6C illustrate a particular example of the additional entry information extraction processing;

FIG. 7 is a flowchart showing a particular example of the position/skew correction processing;

FIGS. 8A and 8B are explanatory diagrams of moving directions of a second image within a first image;

FIG. 9 illustrates a particular example (1) of a second example of the position/skew correction processing;

FIG. 10 illustrates a particular example (2) of the second example of the position/skew correction processing;

FIG. 11 illustrates a particular example (3) of the second example of the position/skew correction processing;

FIG. 12 illustrates a first image (A) and a second image (B) at a maximum matching level, and a positional relation when the second image (B) is shifted upward, downward, leftward and rightward by one pixel;

FIG. 13 is a conceptual diagram of maximum matching position estimation processing when m(−1)>m(1) holds;

FIG. 14 is a conceptual diagram of the maximum matching position estimation processing when m(−1)<m(1) holds;

FIG. 15 is a conceptual diagram of the maximum matching position estimation processing using a parabola;

FIGS. 16A and 16B illustrate a particular example of an entry-unadded image and an entry-added image, respectively;

FIG. 17 is an explanatory diagram of a problem in the simple subtraction; and

FIG. 18 is an explanatory diagram of another problem in the expansion subtraction.

### DETAILED DESCRIPTION

Generally, an entry-unadded original and an entry-added original are read with an image reading device such as a scanner, thereby scan images of the both originals are obtained. The scan images are compared with each other, thereby an additional entry area is extracted from the entry-added original image. In the additional entry extraction processing, positioning is performed between the entry-unadded original image and the entry-added original image, and then the entry-unadded original image is subtracted from the entry-added original image (difference extraction), thereby the additional entry area is extracted.

In the difference extraction processing, when the positioning is performed between the entry-unadded original image and the entry-added original image, generally, feature points are extracted from the entire image and positioning is performed between the both images based on the extracted feature point information. However, generally, a scan image is not uniformly displaced due to image skew upon scanning caused by lens distortion, motor rotation unevenness, vibration and the like or by skew of original itself upon printing on paper. That is, the displacement amount and displacement direction of image differ in accordance with position on original.

Accordingly, the positioning in the entire image is locally performed with high accuracy or uniformly performed in the entire image. As a result, high-accuracy difference extraction cannot be performed, or load is imposed on the difference extraction processing as postprocessing of the positioning processing. More particularly, additional processing is performed so as to increase the accuracy of difference extraction, or the processing time is prolonged.

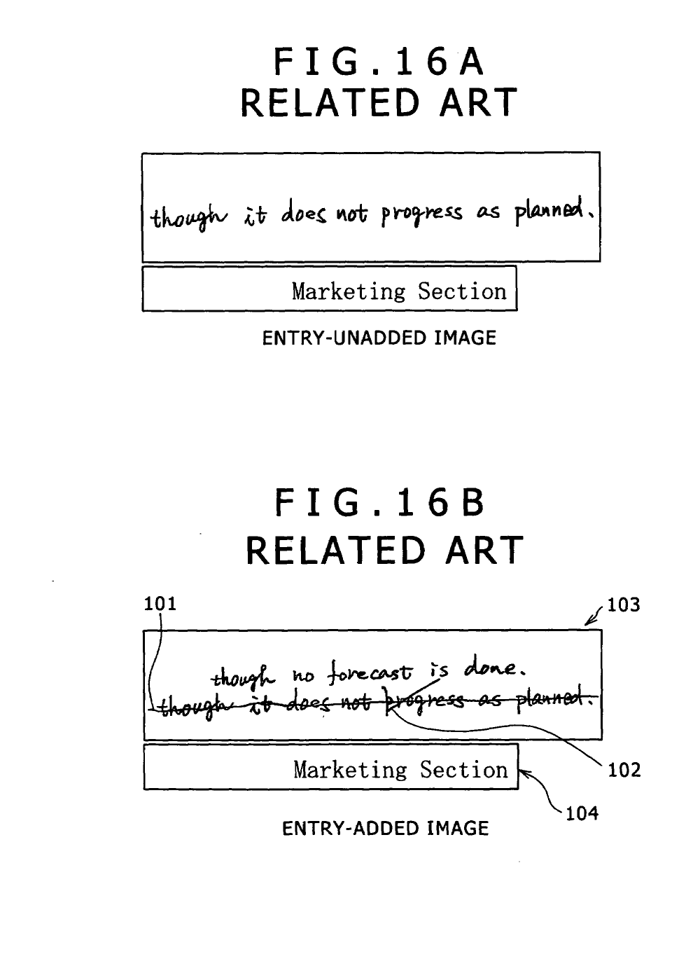

Next, FIG. 16 shows an example with an entry-unadded original (A) where a hand-write additional entry (first additional entry) of a Japanese sentence meaning “though it does not progress as planned”, has been made in a form paper original with printed Japanese characters “marketing section”, and an entry-added original (B) where a line segment 61 to delete the sentence “though it does not progress as planned” and a seal 62, and an additional entry (second additional entry) of a corrective sentence “though no forecast is made” has been made in the entry-unadded original (A).

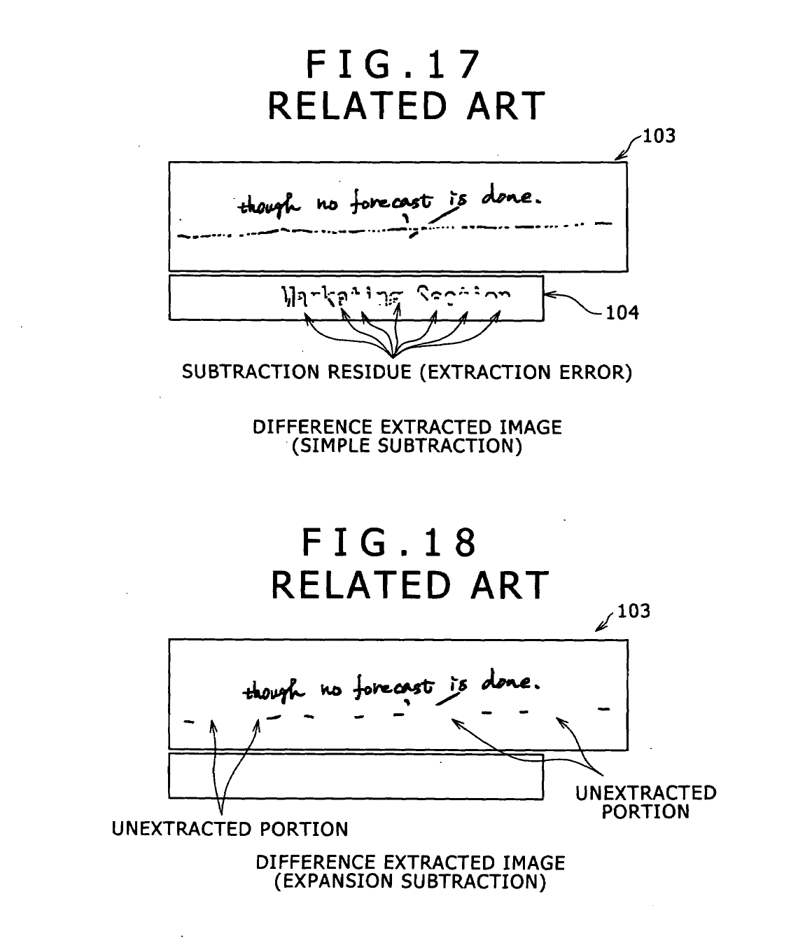

In these entry-unadded original (A) and entry-added original (B), when the difference extraction processing is performed using the above-described simple subtraction as a basic difference extraction processing, assuming that the positioning is accurately performed on an additional entry area 63 to be extracted from the entry-added original (B), the additional entry area 63 can be extracted. However, when an image displacement occurs in a form area 64 with respect to the entry-unadded original (A) due to a difference in an image displacement amount and a displacement direction according to position on the original, subtraction residual occurs in the form area 104 as shown in FIG. 17. Thus an erroneous extraction occurs in a portion different from the additional entry area.

To avoid such erroneous extraction, conventionally, difference extraction processing has been performed using so-called expansion subtraction. In this processing, the respective entry-unadded and entry-added original images are divided into a predetermined number of areas, and image positioning is performed by divided area. Then, expansion processing is performed on the entry-unadded original image, and the image obtained by the expansion processing on the entry-unadded original image is subtracted from the entry-added original image.

However, in the difference extraction processing using the expansion subtraction, as the image obtained by the expansion processing on the entry-unadded original is subtracted from the entry-added original image, subtraction is excessively performed in the expanded portion. As shown in FIG. 18, faint characters, patchy lines and the like occur, or an unextracted portion occurs in the additional entry extraction.

Hereinbelow, an exemplary embodiment of the present invention will be described in detail with reference to the drawings.

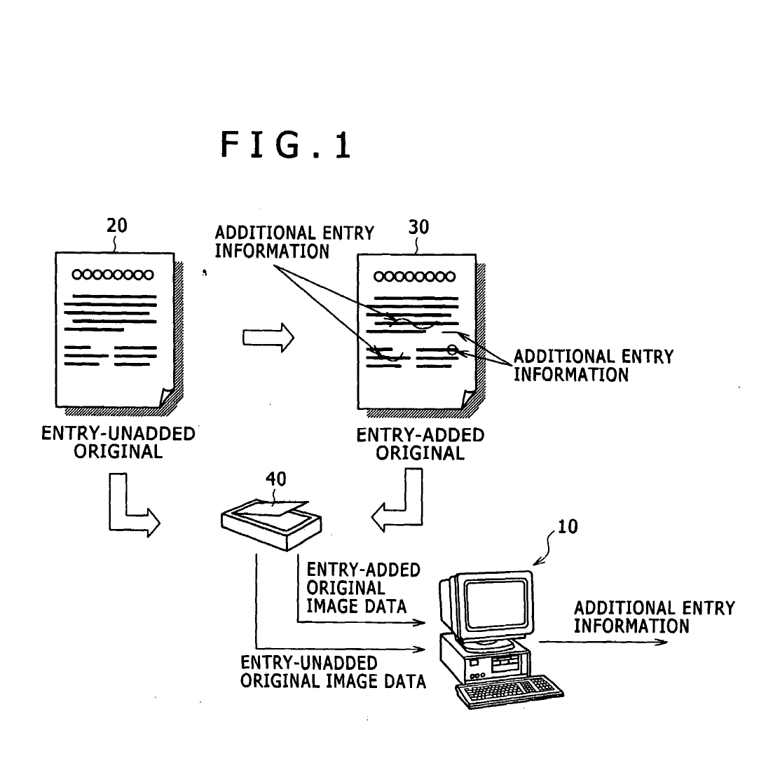

FIG. 1 schematically illustrates the system configuration of an image processing system to which the present invention is applied. In FIG. 1, an image processing apparatus 10 corresponds to the image processing apparatus according to the present invention. The image processing apparatus 10 performs difference extraction processing of comparing the image of an original before execution of additional entry (hereinbelow, referred to as an “entry-unadded original”) 20 with the image of an original after the execution of the additional entry (hereinbelow, referred to as an “entry-added original”) 30, obtaining the difference between the images, thereby extracting an additional entry portion (additional entry information) from the entry-added original 30.

When a hand-write additional entry (first additional entry) has been made into a form paper original and a further additional entry (second additional entry) has been made into the paper original after the execution of the hand-write additional entry, the paper original after the execution of the first additional entry becomes the entry-unadded original 20, and the paper original after the execution of the second additional entry becomes the entry-added original 30. Similarly, when the third and subsequent additional entries have been made, the paper original after the execution of the second and subsequent additional entries becomes the entry-unadded original 20, and the paper original after the execution of the third and subsequent additional entries becomes the entry-added original 30.

In the image processing system according to the exemplary embodiment, the entry-unadded original 20 and the entry-added original 30 are read with an image reading device 40 such as a scanner, and entry-unadded original image data and entry-added original image data obtained by the image reading are inputted into the image processing apparatus 10. The image processing apparatus 10 performs difference extraction processing to obtain the difference between the both original images using the entry-added original image data and the entry-unadded original image data and extract additional entry information.

As a feature of the image processing apparatus 10 according to the present invention, the image processing apparatus 10 can perform the above-described difference extraction processing with high accuracy even when image displacement amount and displacement direction differ in accordance with position on paper original.

Hereinbelow, the image processing apparatus 10 and its processing program will be specifically described.

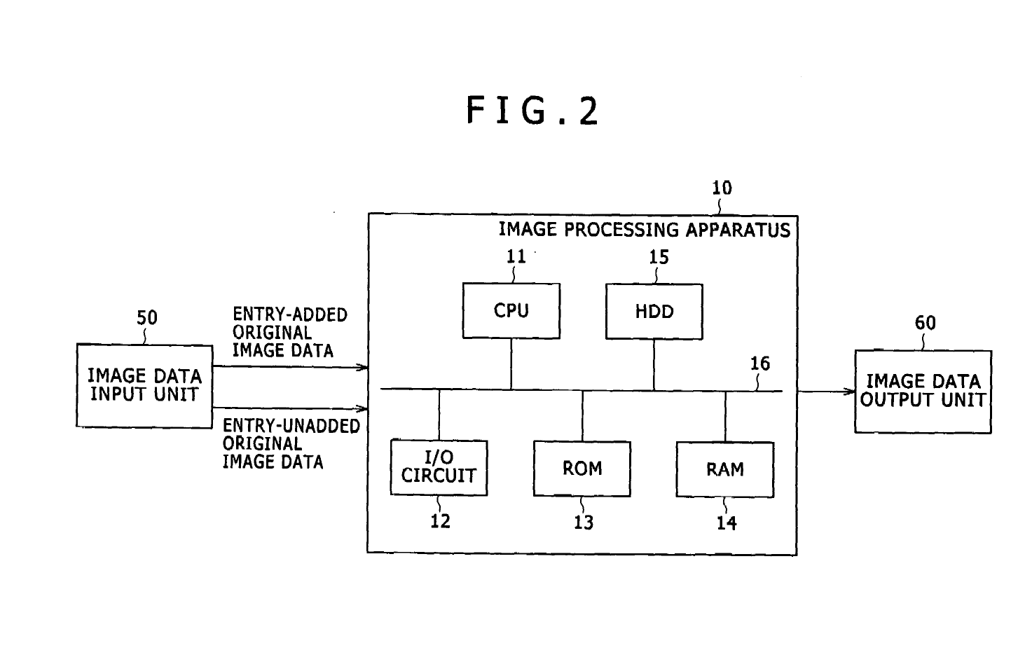

FIG. 2 is a block diagram showing a more particular configuration of the image processing system including the image processing apparatus 10 according to the present invention. In FIG. 2, the image data input unit 50 corresponds to the image reading device 40 in FIG. 1. The image data input unit 50 inputs entry-unadded original image data obtained by reading the image of the entry-unadded original 20 and entry-added original image data obtained by reading the image of the entry-added original 30 into the image processing apparatus 10 according to the present invention.

Note that in the present exemplary embodiment, the entry-unadded original image data and the entry-added original image data are read with the image reading device 40 such as a scanner and these image data are inputted into the image processing apparatus 10. However, regarding the entry-unadded or image data as a reference of difference extraction, it may be arranged such that the image data of the entry-unadded original 20 supplied from a server is inputted in the image processing apparatus 10. Otherwise, it may be arranged such that the image data of the entry-unadded original 20 is previously stored in a memory of the image processing apparatus 10 and the image data is employed.

The image processing apparatus 10 has a CPU (Central Processing Unit) 11, an I/O circuit 12, a ROM 13, a RAM 14, a HDD (Hard Disk Drive) 15 and the like. These constituent elements are mutually communicably connected via a bus line 16.

The CPU 11 performs control of the entire image processing apparatus 10 including calculation processing. The I/O circuit 12 manages inputs/outputs with peripheral devices including the image data input unit 50 and an image data output unit 60. The ROM 13 holds programs of various processings executed under the control of the CPU 11. The RAM 14 is a primary storage device used upon execution of the various processings. The HDD 15 holds image data processed under the control of the CPU 11, image data inputted from the outside and the like.

The image data output unit 60 includes output devices such as a printer and a display and a controller for these devices. The image data output unit 60 print-outputs additional entry information (additional entry extraction information) extracted by the processing in the image processing apparatus 10 from the image of the entry-added original 30 onto a print (recording) sheet or display-outputs the information on a display screen.

### Exemplary Embodiment

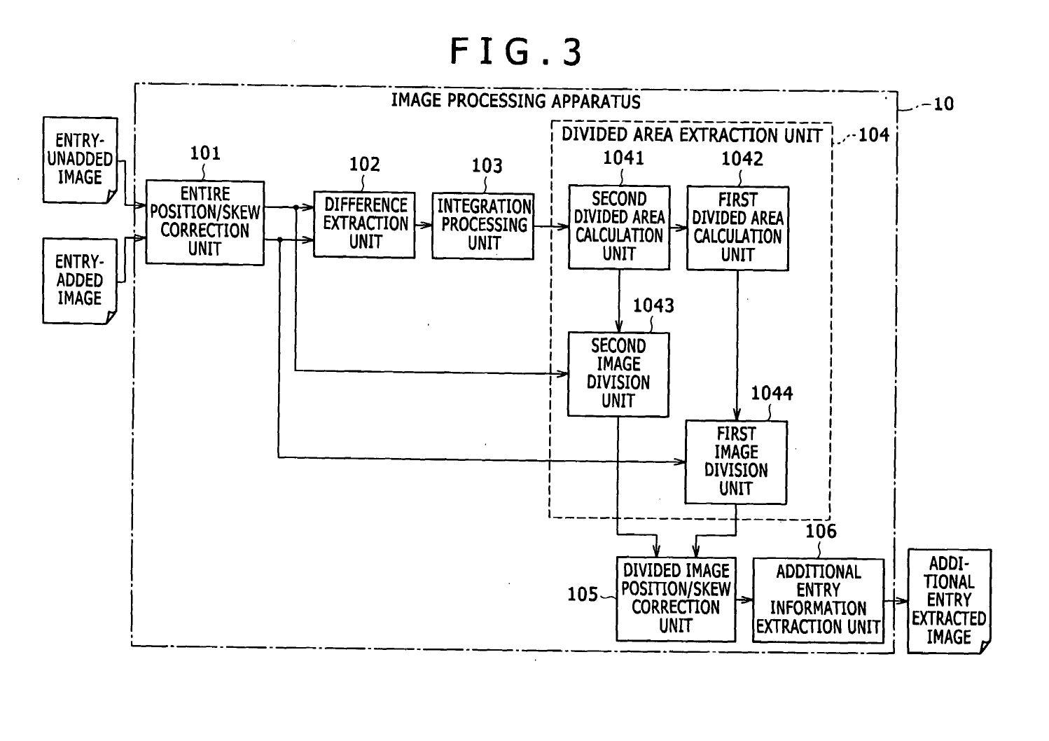

FIG. 3 is a block diagram showing the functional construction of the image processing apparatus 10 according to the exemplary embodiment of the present invention.

As shown in FIG. 3, the image processing apparatus 10 according to the present exemplary embodiment has an entire position/skew correction unit 101, a difference extraction unit 102, an integration processing unit 103, a divided area extraction unit 104, a divided image position/skew correction unit 105, and an additional entry information extraction unit 106.

### (Entire Position/Skew Correction Unit)

The entire position/skew correction unit 101 corresponds to a first positioning part in the claims. The entire position/skew correction unit 101 performs relative positioning between the image of an entry-unadded original (hereinbelow, referred to as an “entry-unadded image”) as a first original and the image of an entry-added original (hereinbelow, referred to as an “entry-added image”) as a second original with respect to the entire original, thereby corrects displacement, skew and the like between the both images. In the present exemplary embodiment, the entry-unadded image is used as a reference image, and the displacement and skew of the entry-added image are corrected in correspondence with the entry-unadded image. Note that it may be arranged such that the entry-added image is used as a reference image and the displacement and skew of the entry-unadded image are corrected in correspondence with the entry-added image.

Note that the image displacement and skew include three types of displacement, i.e., parallel displacement, rotational displacement and magnification displacement. For example, image transformation is performed one of the images (the entry-added image in this example) employing a well-known image transformation method using affine transformation, with a displacement amount in paper original widthwise direction (X), a vertical displacement (Y), a rotation angle (θ) and a magnification (β) as positioning correction coefficients (parameters), thereby the displacement between the two images can be corrected.

### (Difference Extraction Unit)

The difference extraction unit 102 corresponds to a first extraction part in the claims. The difference extraction unit 102 compares the entry-unadded image with the entry-added image subjected to the positioning (correction of displacement and skew) by the entire position/skew correction unit 101, thereby extracts difference information. More particularly, the difference extraction unit 102 extracts the difference information by subtracting an image, obtained by expanding ON pixels of the entry-unadded image, from the position/skew-corrected entry-added image.

Note that the ON pixel means, e.g., in a binary image, a black pixel (or white pixel) on the background of white (or black) color. Further, the size of expanding the ON pixels of the entry-unadded image is, e.g., 5×5 pixels.

### (Integration Processing Unit)

The integration processing unit 103 corresponds to an integration processing part in the claims. The integration processing unit 103 integrates difference extracted pixels seem to belong to the same area into an integrated area based on difference extracted pixels as the difference information extracted by the difference extraction unit 102. Note that the integration means combining difference extracted pixels seem to belong to the same area into one pixel group.

As the integration processing by the integration processing unit 103, for example, the following processings (1) to (4) are considered.
(1) The distance between extracted pixels, e.g., a Euclidean distance, is obtained. When the Euclidean distance is equal to or less than a predetermined threshold value, the pixels are regarded as pixels belonging to the same area, and combined into an integrated area.
(2) A predetermined sized figure, i.e., a predetermined sized rectangle is generated around an extracted pixel as a center. When the rectangles can be overlapped with each other, the pixels are regarded as pixels belonging to the same area, and combined into an integrated area. Note that in this processing, the distance in the processing (1) is a city-block distance.
(3) The extracted pixels are classified by connected pixel group using, e.g., labeling processing, and a circumscribed rectangle is obtained by connected pixel group and extended (expanded) by a predetermined size. Then, when the extended-circumscribed rectangles are overlapped with each other, the connected pixel groups are regarded as pixel groups belonging to the same area, and combined into an integrated area. Note that this processing is accelerated processing of the processing (2).
(4) Labeling processing is performed on the position/skew corrected entry-added image. Then, labels (connected pixel groups) where extracted pixels are included (belong) are judged. The extracted pixels belonging to the same label are regarded as pixels belonging to the same area, and combined into an integrated area. Note that a label (connected pixel group) including extracted pixels may be set as an integrated area.

### (Divided Area Extraction Unit)

The divided area extraction unit 104 corresponds to an area division part in the claims. The divided area extraction unit 104 performs area dividing on the entry-unadded image and the entry-added image based on the difference information extracted by the difference extraction unit 102, by extension, the result of integration processing by the integration processing unit 103, i.e., the integrated area.

As shown in FIG. 3, the divided area extraction unit 104 includes a second divided area calculation unit 1041, a first divided area calculation unit 1042, a second image division unit 1043, and a first image division unit 1044.

The second divided area calculation unit 1041 sets a predetermined area including the integrated area obtained by the integration processing unit 103 as a second divided area of the entry-unadded image. As the area division processing by the second divided area calculation unit 1041, for example, the following processings (1) and (2) are considered.
(1) The circumscribed rectangle of the integrated area (pixel group) is extended (expanded) by a predetermined size as a second divided area. Note that the extension size may be 0.
(2) A convex hull is generated for the pixel group of integrated area, and the convex hull is extended (expanded) by a predetermined size as a second divided area. Note that the extension size may be 0.

Note that the convex hull means a minimum convex polygon including a point set. The convex hull may also be regarded as a minimum closed circuit surrounding plural points.

The first divided area calculation unit 1042 sets an area expanded to have a predetermined-size larger than the second divided area calculated by the second divided area calculation unit 1041, as a first divided area of the entry-added image. In this exemplary embodiment, an area expanded to have a predetermined-size larger than the second area is calculated as a first divided area based on the second area. However, it may be arranged such that, as in the case of the second divided area calculation unit 1041, an area expanded to have a predetermined-size larger than the second divided area is calculated as a first divided area, based on the integrated area obtained by the integration processing unit 103 as a reference.

The second image division unit 1043 cuts out (divides) an image corresponding to the second divided area from the entry-unadded image, based on the second divided area calculated by the second divided area calculation unit 1041, as a second image. The first image division unit 1044 cuts out an image corresponding to the first divided area from the position/skew corrected entry-added image, based on the first divided area calculated by the first divided area calculation unit 1042, as a first image.

### (Divided Image Position/Skew Correction Unit)

The divided image position/skew correction unit 105 corresponds to a second positioning part in the claims. The divided image position/skew correction unit 105 locally performs positioning between the first image (entry-unadded image) and the second image (entry-added image), based on the difference extracted pixels as the difference information extracted by the difference extraction unit 102.

More particularly, in this exemplary embodiment, as the size of the first image is larger than that of the second image, the divided image position/skew correction unit 105 performs pattern matching so as to superimpose the second image over the first image while changing the position of the second image within the first image, thus performs position/skew correction in a position at a high matching level as a correction position. As the position/skew correction processing by the divided image position/skew correction unit 105, for example, the following processings (1) and (2) are considered.
(1) Pattern matching is performed in all the positions while the second image is moved upward, downward, leftward and rightward directions by one pixel within the first image, and a position where the matching level (matching degree) is the highest is determined as a position/skew correction position. For example, the matching level is represented by the number of ON pixel positions corresponding in the first and second images.

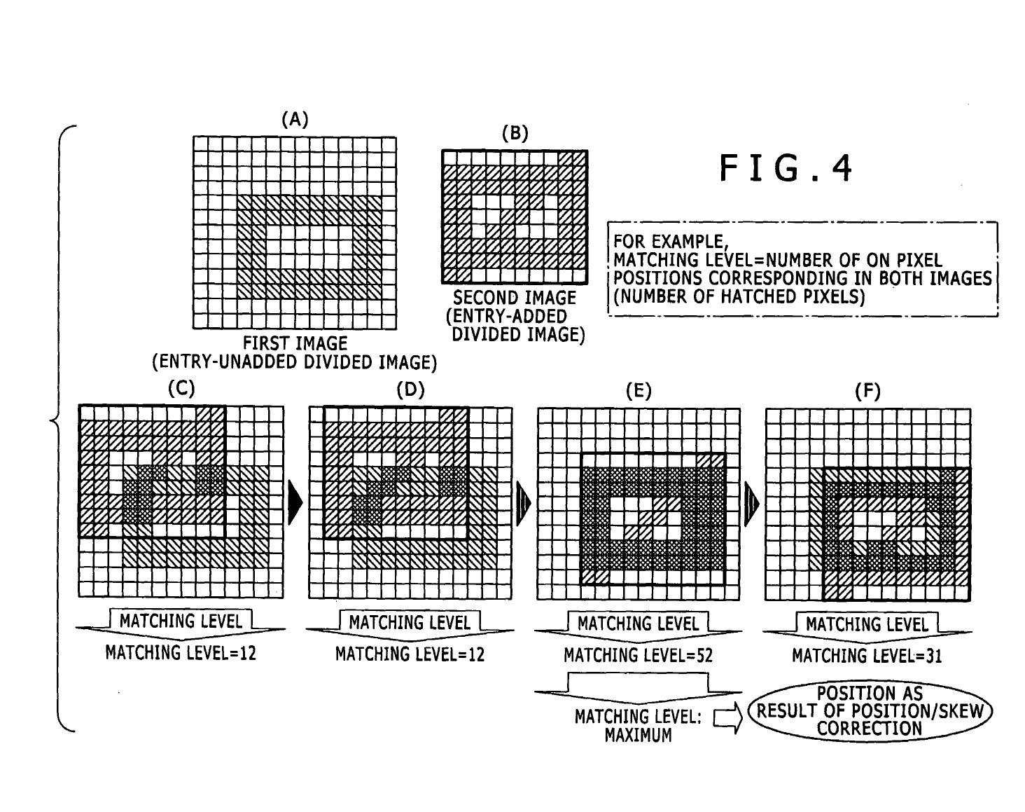

More particularly, as shown in FIG. 4, in the case of a first image (A) having a rectangular ring-shaped image and a second image (B) having additional information of a diagonal straight line on the ring shaped image, the second image (B) is moved from the upper left position rightward by one pixel with respect to the first image (A), next, moved downward by one pixel then moved from the left side to the right side. This processing is repeated until the second image arrives at the lower right position in the figure.

These figures show matching levels in four positions (C) to (F), i.e., matching level=12 in the position (C), matching level=12 in the position (D), matching level=52 in the position (E) and matching level=31 in the position (F). Accordingly, the position (E) is determined as a position/skew correction position.
(2) Using the correction position by the entire position/skew correction unit 101 as a reference position, the matching degree between the first image and the second image in the reference position is calculated. Then, the second image is moved in four directions (upward, downward, leftward and rightward directions) or eight directions (upward, downward, leftward, rightward, diagonal upper-leftward, diagonal upper-rightward, diagonal lower-leftward and diagonal lower-rightward directions), while the matching degree is calculated in the respective positions. More particular processing in the case of this processing will be described later.

In the processing (2), when the matching degree in the reference position is equal to or lower than a maximum matching degree in the four or eight directional position, the reference position is moved to the position with the maximum matching degree. Further, when the matching degree in the reference position is equal to or higher than the maximum matching degree in the four or eight directional position, the reference position is determined as a position/skew correction position.

Note that in the present exemplary embodiment, the size of the first image is larger than that of the second image; however, it may be arranged such that the size of the second image is set to be larger than that of the first image and position/skew correction is performed. In this case, the divided image position/skew correction unit 105 performs pattern matching so as to superimpose the first image over the second image while changing the position of the first image within the second image, and performs position/skew correction at a position with a high matching level as a correction position.

### (Additional Entry Information Extraction Unit)

The additional entry information extraction unit 106 corresponds to a second extraction part in the claims. The additional entry information extraction unit 106 compares the first image with the second image subjected to the positioning by the divided image position/skew correction unit 105, and extracts the difference between the images, thereby extracts additional entry information from the second image. More particularly, the additional entry information extraction unit 106 compares the first image with the second image subjected to the position/skew correction by the divided image position/skew correction unit 105, and extracts the difference between the images, thereby extracts the additional entry information from the second image. As the additional entry information extraction by the additional entry information extraction unit 106, the following processings (1) and (2) are considered.
(1) An image obtained by expanding ON pixels of the first image is subtracted from the position/skew corrected second image. The size of expansion (expansion number) in the additional entry information extraction unit 106 is, e.g., 3×3 pixels. At this time, as the relation-between the size of expansion in the difference extraction unit 102 and the size of expansion in the additional entry information extraction unit 106, the size of expansion in the difference extraction unit 102 may be equal to or larger than the size of expansion in the additional entry information extraction unit 106.
(2) In the position at the maximum matching level and peripheral positions at high matching levels in the processing by the divided image position/skew correction unit 105, the first image is subtracted from the second image in plural positions.

In the case of the processing (2), it is necessary to fix the position of the second image while the first image is moved. Accordingly, when the second image is moved and a matching level is calculated, the first image is subtracted from the second image in plural positions in correspondence with the positional relation. Further, a matching level threshold value around the position at the maximum matching level may be calculated from the maximum matching level. For example, the maximum matching level is multiplied by a predetermined coefficient. Otherwise, a predetermined threshold value may be used.

The additional entry information extracted by the additional entry information extraction unit 106 may be outputted as single information. Otherwise, it may be arranged such that the position in the entire image is preserved, and the difference pixels (additional entry information) are represented as one image.

The respective constituent elements of the image processing apparatus 10 having the above construction, i.e., the entire position/skew correction unit 101, the difference extraction unit 102, the integration processing unit 103, the divided area extraction unit 104 (the second divided area calculation unit 1041, the first divided area calculation unit 1042, the second image division unit 1043 and the first image division unit 1044), the divided image position/skew correction unit 105 and the additional entry information extraction unit 106 may be realized with a software structure utilizing a computer device to execute respective functions of information storage processing, image processing, calculation processing and the like by execution of a predetermined program, such as a PC (Personal Computer).

Note that the realization of the above constituent elements is not limited by that by a software structure, but may be realized by a hardware structure or a combination of hardware and software. When the constituent elements are realized by a software structure, a program to cause a computer to function as the entire position/skew correction unit 101, the difference extraction unit 102, the integration processing unit 103, the divided area extraction unit 104, the divided image position/skew correction unit 105 and the additional entry information extraction unit 106, is the image processing program according to the present invention.

Further, it can be said that a program to execute processings at the respective process steps in the following processing sequence is the image processing program according to the present invention. The image processing program may be installed in the computer in advance. However, when the program is not installed in advance, it may be stored in a computer readable storage medium and the medium may be provided, otherwise, the program may be delivered via a cable or wireless communication part.

### (Additional Entry Information Extraction Processing)

Next, an example of additional entry information extraction processing (difference extraction processing) of obtaining the difference between an entry-unadded original image (entry-unadded image) and an entry-added original image (entry-added image) thereby extracting additional entry information will be described using the flowchart of FIG. 5.

First, the displacement and skew between the entry-unadded image as a first original and the entry-unadded image as a second original are corrected by performing relative positioning on the entire original (step S1). In this example, with the entry-unadded image as a reference, the displacement and skew of the entry-added image are corrected in correspondence with the entry-unadded image. The processing at step S11 corresponds to the processing in the entire position/skew correction unit 101 in FIG. 3.

Next, the difference information is extracted by comparing the entry-unadded image with the entry-added image subjected to the correction of displacement and skew (step S12). In this example, the difference information is extracted by subtracting an image where ON pixels of the entry-unadded image are expanded from the position/skew corrected entry-added image. The processing at step S12 corresponds to the processing in the difference extraction unit 102 in FIG. 3.

Next, based on the difference extracted pixels as the extracted difference information, difference extracted pixels deemed to belong to the same area are integrated into an integrated area (pixel group) (step S13). The processing at step S13 corresponds to the processing in the integration processing unit 103 in FIG. 3.

Next, when n integrated areas exist, to perform the difference extraction processing sequentially from the first integrated area to the n-th integrated area, an integrated area number i is set to “1” (step S14), then, it is determined whether or not i>n holds (step S15). The following processing is repeatedly performed until it is determined that i>n holds.

When it is determined that i≦n holds, a predetermined area including the i-th integrated area is determined as a second divided area of the entry-added image (step S16). Next, an area expanded to have a predetermined-size larger than the second divided area is determined as a first divided area of the entry-unadded image (step S17). The respective processings at steps S16 and S17 correspond to the respective processings in the second and first divided area calculation units 1041 and 1042.

Next, an image corresponding to the second divided area is cut out (divided) from the position/skew corrected entry-added image as a second image (step S18). Next, an area corresponding to the first divided area is cut out from the entry-unadded image as a first image (step S19). The respective processings at these steps S18 and S19 correspond to the respective processings in the second and first image division units 1043 and 1044 in FIG. 3.

Next, the position of the second image is moved within the first image. A position with the maximum matching degree, i.e., a position at the highest matching level, is determined as a position/skew correction position (step S20). The processing at step S20 corresponds to the processing in the divided image position/skew correction unit 105 in FIG. 3. Note that particular processing of the position/skew correction will be described later.

Next, the first image is compared with the position/skew corrected second image then the difference between the images is extracted, thereby the additional entry information is extracted from the second image (step S21). The processing at step S21 corresponds to the processing in the additional entry information extraction unit 106 in FIG. 3.

Next, the integrated area number i is incremented (step S22), then the process returns to step S15, and the processings at steps S16 to S22 are repeated until it is determined that i>n holds.

When it is determined at step S15 that i>n holds, the additional entry information (difference pixels) obtained by the difference extraction in the respective integrated areas with numbers 1 to n is combined and outputted as one image (step S23). Note that when it is not necessary to represent the difference pixels as one image, the processing at step S23 can be omitted.

The outline of the above-described series of processings will be described. That is, in the additional entry information extraction processing (difference extraction processing) of obtaining the difference between the entry-unadded image as a first image and the entry-added image as a second image thereby extracting additional entry information from the entry-added image, prior to comparison between the both images, first, image positioning is performed with respect to the entire original to obtain approximate difference information. Next, local positioning is performed based on the approximate difference information, and difference information, obtained by difference processing thereafter, is extracted as additional entry information.

The positioning with respect to the entire original is coarse positioning of uniform positioning in the entire image. By the coarse positioning processing, approximate difference information can be obtained. Next, positioning is locally performed between the entry-unadded image and the entry-added image based on the difference information. The local positioning is fine positioning of positioning with high accuracy with respect to an additional entry portion to be extracted. By the fine positioning processing, accurate difference information can be obtained in the difference processing thereafter.

In this manner, the two-step positioning processing including the entire positioning processing (coarse positioning processing) and the local positioning processing (fine positioning processing) enables high-accuracy positioning with respect to an additional entry position (additional entry information) to be extracted. Accordingly, even when an image displacement amount and a displacement direction differ in accordance with position on paper original, the extraction of the additional entry information from the entry-added original can be performed with high accuracy.

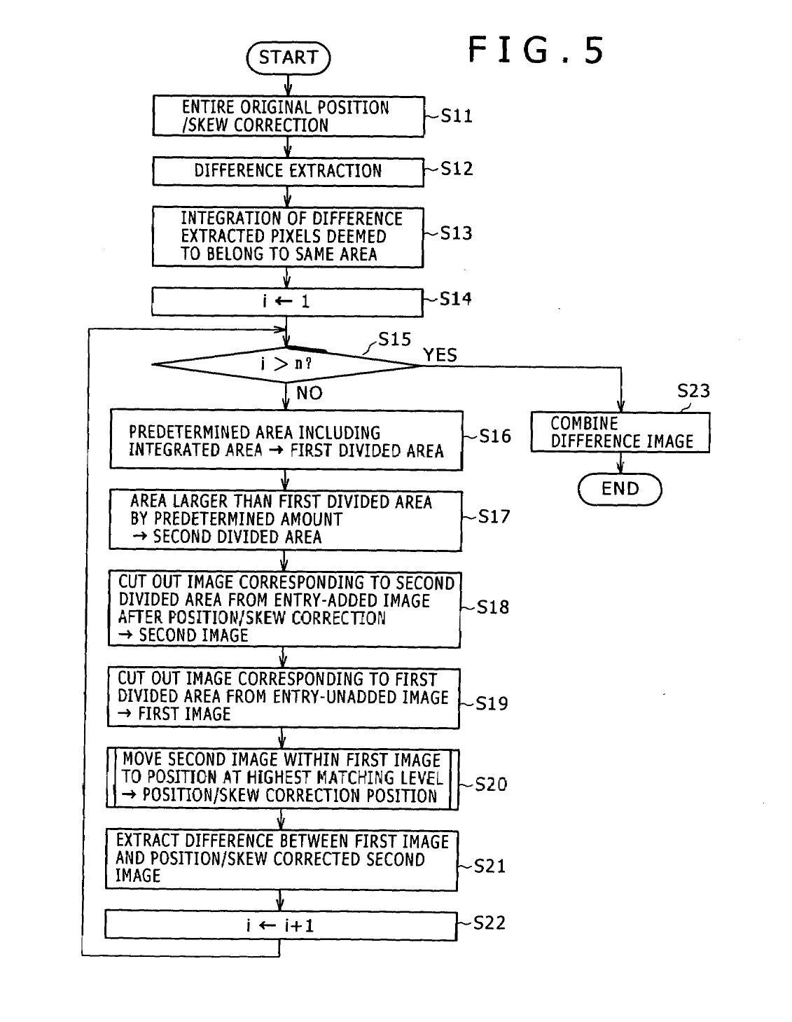

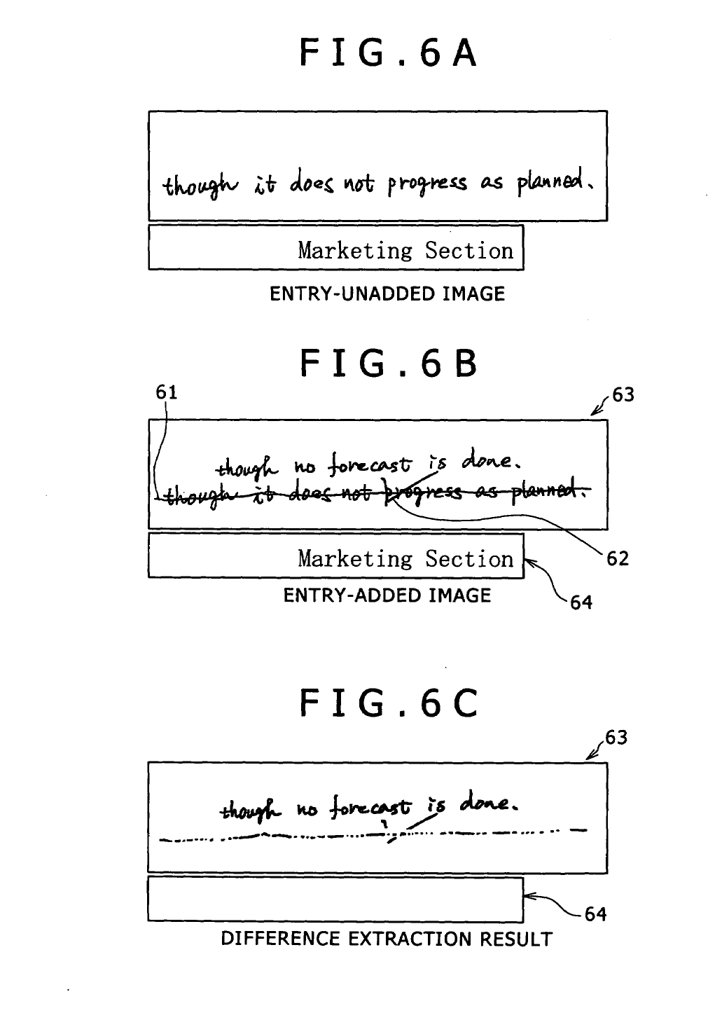

Next, FIGS. 6A to 6C show an example with an entry-unadded original 6A where a hand-write additional entry (first additional entry) of a Japanese sentence meaning “though it does not progress as planned”, has been made in a form paper original with printed Japanese characters “marketing section”, and an entry-added original 6B where a line segment 61 to delete the sentence “though it does not progress as planned” and a seal 62, and an additional entry (second additional entry) of a corrective sentence “though no forecast is made” has been made in the entry-unadded original 6A.

With respect to these entry-unadded original 6A and entry-added original 6B, an additional entry area 63 is extracted from the entry-added original 6B by application of the difference extraction processing according to the present exemplary embodiment. As fine positioning processing is performed on the additional entry area 63 based on difference information obtained by difference processing after coarse positioning processing, apparent from a difference extraction result 6C, the additional entry area 63 can be extracted with high accuracy.

At this time, even when an image displacement has occurred in the entry-unadded original 6A in a form area 64 due to difference in image displacement and displacement direction in accordance with position on original, the fine positioning processing is performed on the form area 64 separately from the additional entry area 63, based on difference information obtained by difference processing after the coarse positioning processing. Accordingly, in the form area 64, problems such as erroneous extraction in difference extraction processing using simple subtraction or occurrence of unextracted additional entry portion in difference extraction processing using expansion subtraction can be prevented.

### (Position/Skew Correction Processing)

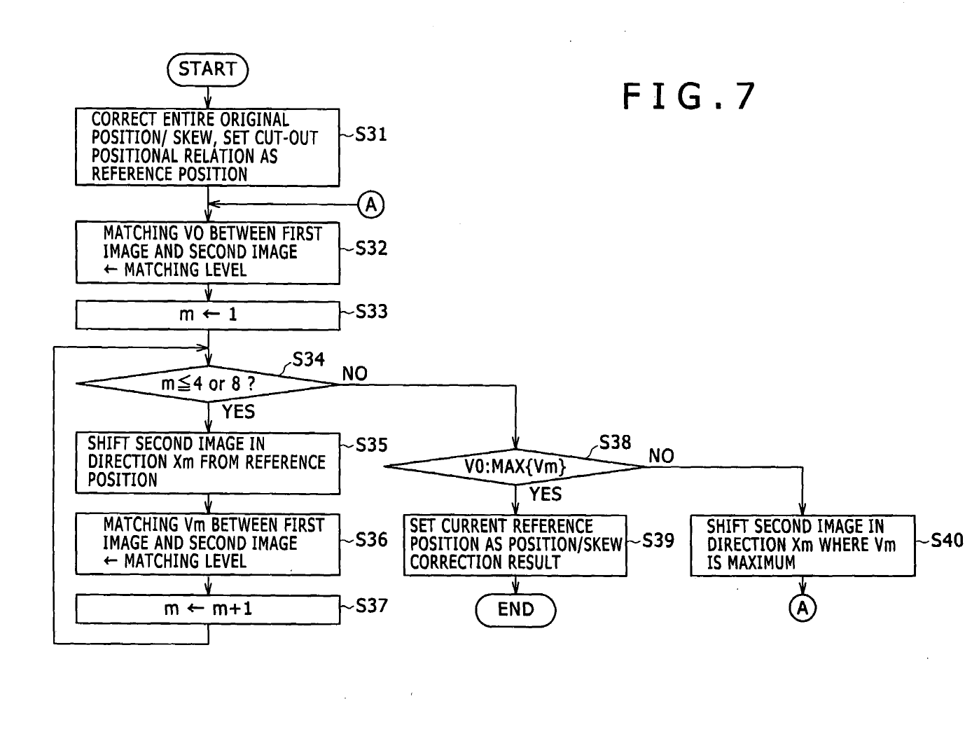

Next, a particular example of the position/skew correction processing at step S20 will be described with reference to the flowchart of FIG. 7. The position/skew correction processing corresponds to processing in the second processing (2) of the above-described two processings (1) and (2) in the divided image position/skew correction unit 105.

First, the entire position/skew correction is performed, and a cut out positional relation is set as a reference position (step S31). In the present example, the size of first image (entry-unadded divided image)≧the size of second image (entry-added divided image) holds.

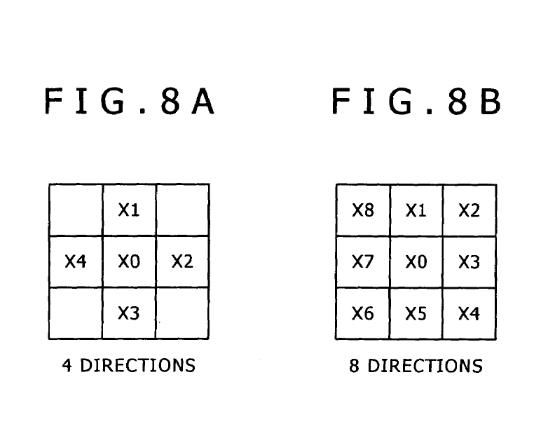

Next, matching is performed between the first image and the second image, and the matching level at this time is V0 (step S32). Then the moving direction order m of the second image within the first image is set to “1” (step S33). As shown in FIGS. 8A and 8B, as the moving directions of the second image within the first image, four directions, upward, downward, leftward and rightward directions 8A, and eight directions of upward, downward, leftward, rightward, diagonal upper-leftward, diagonal upper-rightward, diagonal lower-leftward and diagonal lower-rightward directions 8B are considered. The moving direction order m is, e.g., clockwisely 1, 2, 3, . . . from a position above the reference position X0.

Next, it is determined whether or not the moving direction order m is equal to or smaller than 4 or 8 (step S34). When m≦4 or 8 holds, the second image is shifted by a predetermined number of pixels, e.g., one pixel, in a direction Xm (X1, X2, X3, . . . ) with respect to the reference position X0 (step S35). Then, matching is performed between the first image and the second image, and the matching level at this time is Vm (step S36).

Next, the moving direction order m is incremented (step S37), then the process returns to step S34, to repeat the processings at steps S35 to S37 until it is determined m>4 or 8 holds.

When it is determined at step S34 that m>4 or 8 holds, the matching level V0 in the reference position X0 is compared with a maximum matching level MAX{Vm} in the four or eight directional position (step S38). When V0≧MAX{Vm} holds, the current reference position is determined as a position/skew correction result (step S39), and the series of position/skew correction processings is ended.

On the other hand, when V0<MAX{Vm} holds, the second image is shifted by one pixel in the direction Xm where the matching level Vm becomes maximum (step S40). Thereafter, the process returns to step S34 to repeat the processings at step S34 to S37 until it is determined at step S38 that V0≧MAX{Vm} holds.

For example, in a case where the four moving directions are employed, when a previous movement is upward movement, it is not necessary in the current movement to shift the second image in the direction X3. In a case where the eight moving directions are employed, when a previous movement is rightward movement, in the current movement, the second image is shifted merely in X2-X4 directions.

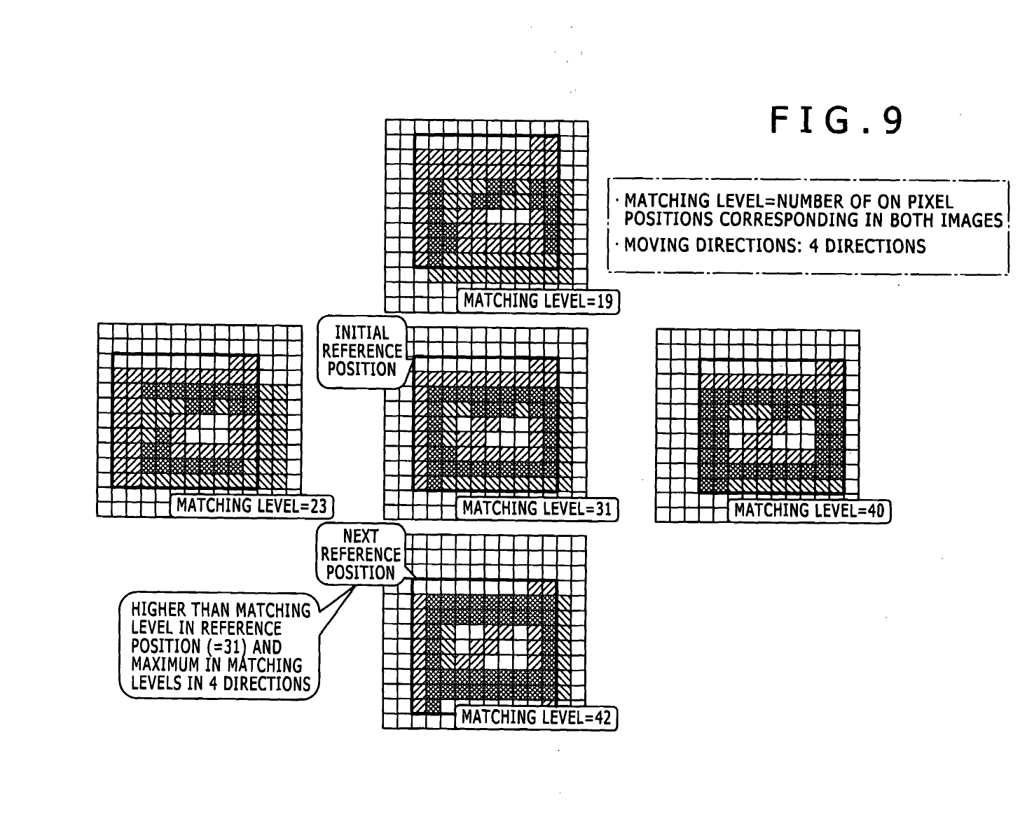

Next, a particular example of the above-described position/skew correction processing will be described with reference to FIGS. 9 to 11. In this example, the number of ON pixel positions corresponding in the first and second images is used as a matching level, and four moving directions are employed as moving directions of the second image.

Also in this example, as shown in FIG. 4, in the case of a first image (A) having a rectangular ring-shaped image and a second image (B) having additional information of a diagonal straight line on the ring shaped image, the central position of the first image (A) is the initial reference position of the second image (B). The matching levels are obtained in the reference position X0, a position X1 where the second image is shifted upward by one pixel, a position X2 where the second image is shifted rightward by one pixel, a position X3 where the second image is shifted downward by one pixel, and a position X4 where the second image is shifted leftward by one pixel.

As it is apparent from FIG. 9, in this example, as the matching level in the reference position X0, V0=31 holds. The matching levels in the respective moving directions are as follows. As the matching level in the upward shift position X1, V1=19 holds; as the matching level in the rightward shift position X2, V2=40 holds; as the matching level in the downward shift position X3, V3=42 holds; and as the matching level in the leftward shift position X4, V4=23 holds.

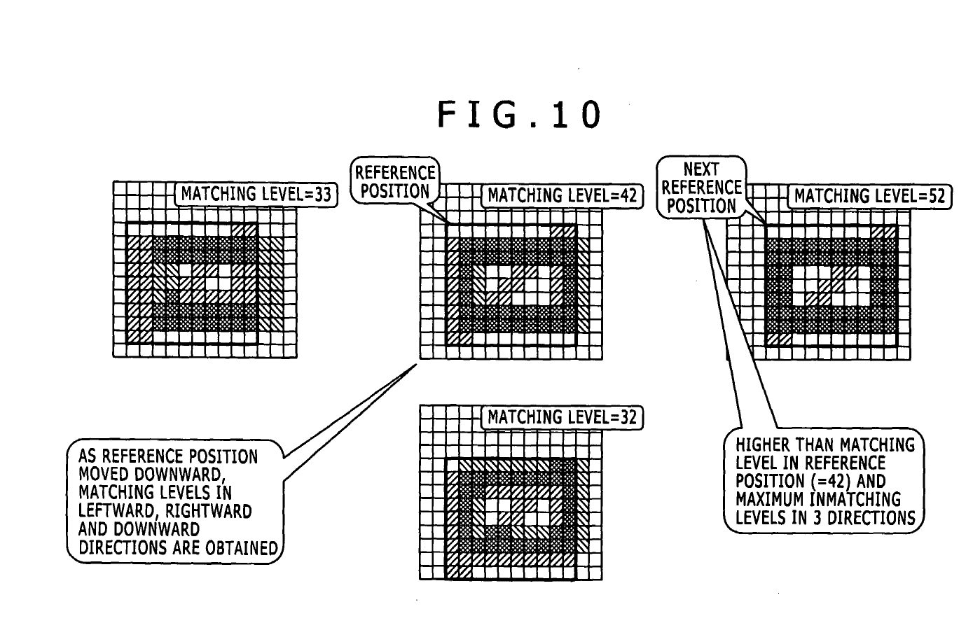

That is, the matching level V3 in the downward shift position X3 is higher than the matching level V0 (=31) in the reference position X0 and maximum among the four directional matching levels V1 to V4. Accordingly, in the next processing, as shown in FIG. 10, the downward shift position X3 is determined as a reference position.

At this time, regarding the matching level in the upward shift position, as the matching level V0=31 has been obtained in the previous processing, it is not necessarily obtained in the current processing. Similarly, regarding the matching level V0 in the current reference position X0, as it has been obtained as the matching level in the downward shift position X3, V3=42, it is not necessarily obtained in the current processing.

That is, as the reference position has been moved downward, in the current processing, the matching levels are obtained in a position X2 shifted rightward by one pixel, a position X3 shifted downward by one pixel, and a position X4 shifted leftward by one pixel. Then, the matching levels in the respective moving directions are as follows. As the matching level in the rightward shift position X2, V2=52 holds; as the matching level in the downward shift position X3, V3=32 holds; and as the matching level in the leftward shift position X4, V4=33 holds.

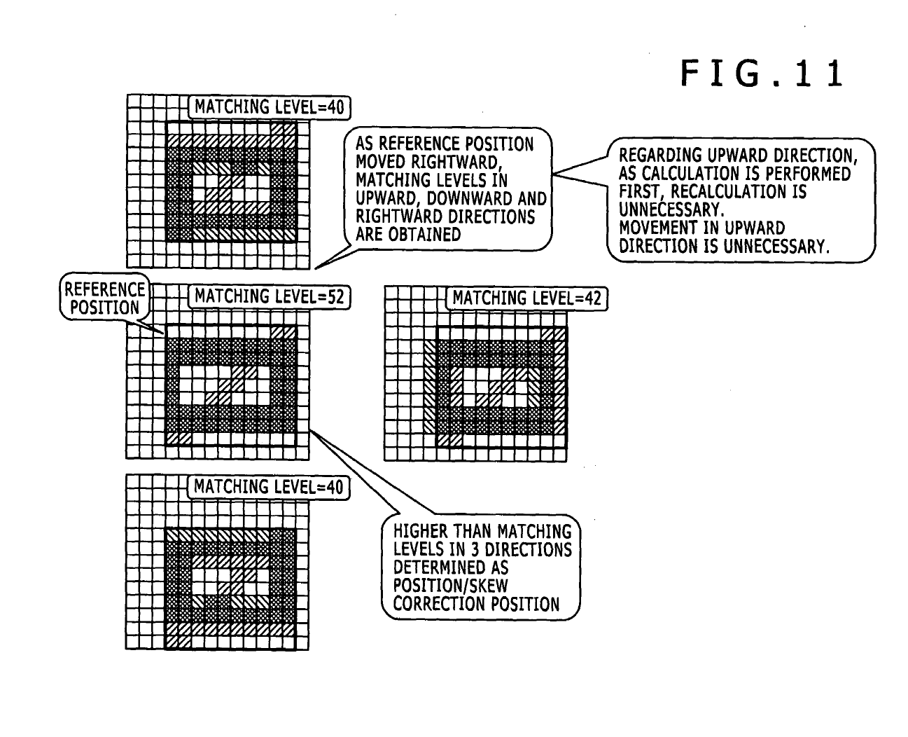

In the current processing, the matching level V2 in the rightward shift position X2 is higher than the matching level V0 (=42) in the reference position X0 and maximum among the three directional matching levels V2 to V4. Accordingly, in the next processing, as shown in FIG. 11, the rightward shift position X2 is determined as a reference position.

At this time, regarding the matching level in the leftward shift position, as the matching level V0=42 has been obtained in the previous processing, it is not necessarily obtained in the current processing. Similarly, regarding the matching level V0 in the current reference position X0, as it has been obtained as the matching level the rightward shift position X2, V2=52, it is not necessarily obtained in the current processing.

That is, as the reference position has been moved rightward, in the current processing, the matching levels are obtained in a position X1 shifted upward by one pixel, a position X2 shifted rightward by one pixel, and a position X3 shifted downward by one pixel. Note that regarding the upward direction, as the matching level in the rightward shift position X2, V2=40 is obtained, it is not necessarily obtained again. Further, it is not necessary to move (shift) the second image upward.

Then, the matching levels in the respective moving directions are as follows. As the matching level in the upward shift position X1, V1=40 holds (result of first processing); as the matching level in the rightward shift position X2, V2=42 holds; and as the matching level in the downward shift position X3, V3=40 holds. As a result, as the matching level V0 in the current reference position X0, i.e., the matching level V2 (=52) in the rightward shift position X2 obtained in the previous processing is higher than the matching levels V1 to V3 in the three directions, the current reference position X0 is determined as a position/skew correction position.

### (Matching Level)

Next, the matching level used in matching point (matching) position calculation will be described. As described above, in the case of binary image, the matching level is obtained as the number of ON pixel positions corresponding in the first image and the second image.

In the case of color image, the matching level is obtained by the following (1) to (3) processings. In this example, the first image is denoted by alphabet A, and the second image, by alphabet B.
(1) The matching level is obtained as the sum of squares of the difference by R (red) G (green) and B (blue) color plain (ΣΣ{A(x,y)−B(x,y)}²). Note that {A(x,y)−B(x,y)} is a Euclidean distance between two color spaces.
(2) The matching level is obtained as the sum of absolute values of the difference among RGB colors (ΣΣ|A(x,y)−B(x,y)|). Note that |A(x,y)−B(x,y)|=|{R of A(x,y)}−{R of B(x,y)}|+|{G of A(x,y)}−{G of B(x,y)}+|{B of A(x,y)}−{B of B(x,y)}| holds.
(3) The matching level is obtained as a cross-correlation coefficient.

$$\frac{{\sum }_{x = 0}^{M - 1} {\sum }_{y = 0}^{N - 1} ( ( A ( x , y ) - \overline{A} ) ( B ( x , y ) - \overline{B} ) )}{\sqrt{{\sum }_{x = 0}^{M - 1} {\sum }_{y = 0}^{N - 1} {( A ( x , y ) - \overline{A} )}^{2}} \times \sqrt{{\sum }_{x = 0}^{M - 1} {\sum }_{y = 0}^{N - 1} {( B ( x , y ) - \overline{B} )}^{2}}} \\ \overline{A} = \frac{1}{MN} {\sum }_{x = 0}^{M - 1} {\sum }_{y = 0}^{N - 1} A ( x , y ) \\ \overline{B} = \frac{1}{MN} {\sum }_{x = 0}^{M - 1} {\sum }_{y = 0}^{N - 1} B ( x , y ) \qquad ( 1 )$$

### In the expression, when the image is a rectangular image, M and N are the numbers of pixels in vertical and lateral directions.

### (Maximum Matching Position Estimation Processing)

In the above description, to obtain the matching point position (matching position), the second image is shifted by pixel within the first image, however, the matching point position does not always exist in pixel units.

Accordingly, to obtain the matching point position more accurately, using a position at a high matching level, the matching levels in the position and its peripheral positions, a position estimated at a maximum matching level is determined as a maximum matching position. The maximum matching position includes a subpixel position. The subpixel is a unit of dividing one pixel.

The maximum matching position estimation processing will be particularly described below. Note that in the processing, the matching levels obtained in the processings (1) and (2) in the divided image position/skew correction unit 105 in FIG. 3 are used. Accordingly, the maximum matching position estimation processing is employed as post processing of the processing (1) or (2) in the divided image position/skew correction unit 105, otherwise, when processing for more accurately detecting a matching position is required, i.e., in accordance with necessity.

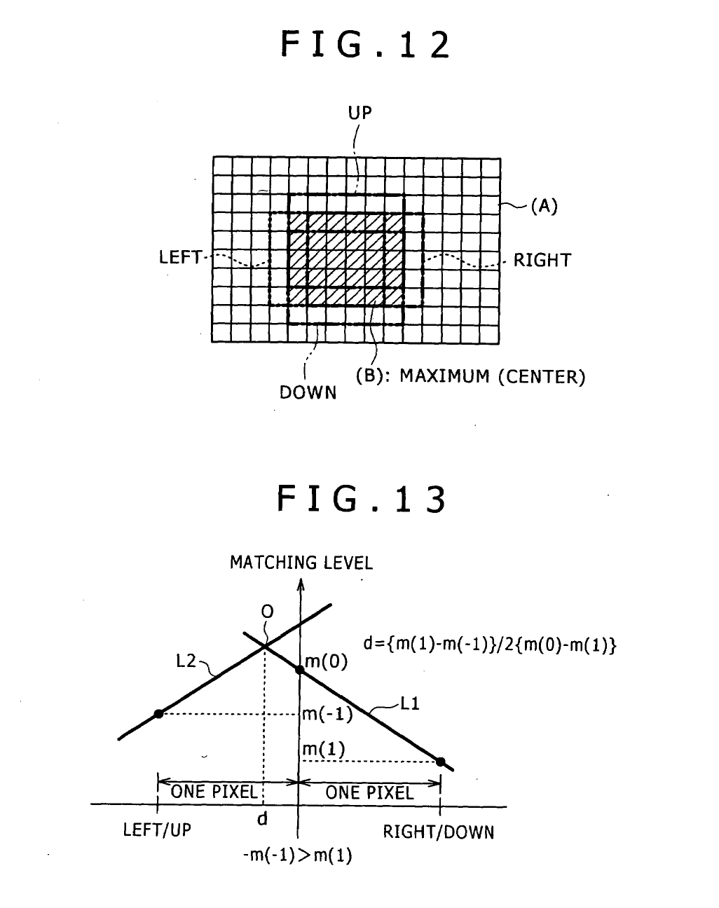

First, as shown in FIG. 12, the second image (B) at a maximum matching level is positioned at the center of the first image (A), then the second image (B) is shifted upward, downward, leftward and rightward by one pixel. FIG. 13 shows an xy coordinate graph with the second image (B) at the maximum matching level as an origin. In the xy coordinate graph, a maximum matching level in a vertical direction (y-direction) is estimated using matching levels in the central, upper and lower positions. Similarly, a maximum matching level in a lateral direction (x-direction) is estimated using matching levels in the central, left and right positions. Then, an intersection between the maximum matching levels in the both directions is estimated as a final maximum matching level.

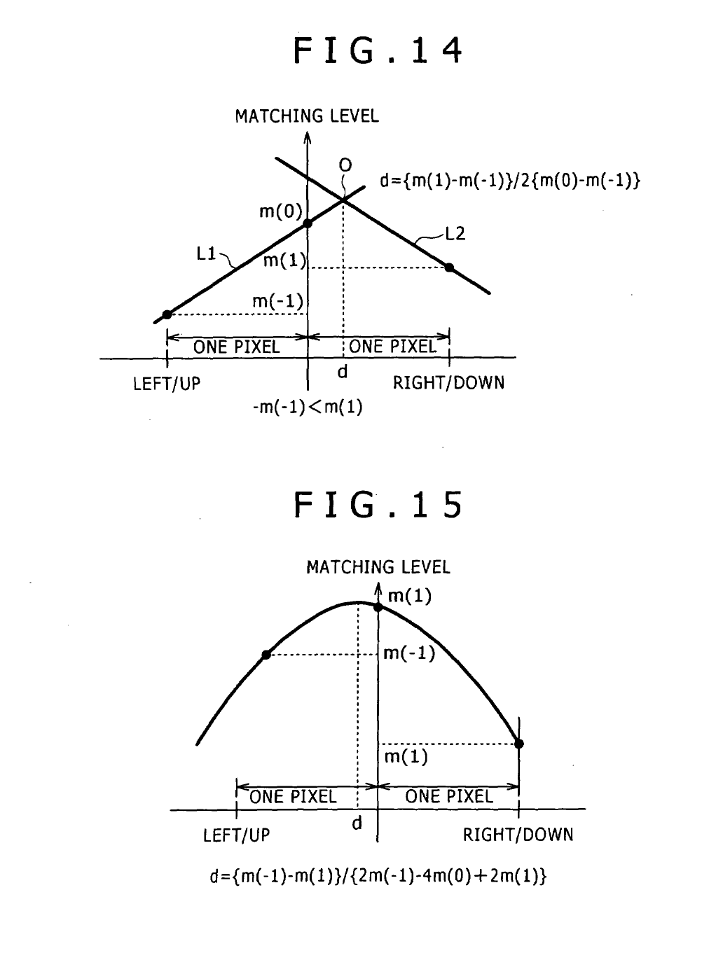

More particularly, in the xy coordinate graph in FIG. 14, assuming that the central matching level is m(0), the right/lower matching level is m(1), and the left/upper matching level is m(−1), a straight line L1 is drawn to connect the central matching level m(0) with the right/lower matching level m(1), then a straight line L2 passing the left/upper matching level m(−1) having an inclination the same as that of the straight line L1 but having an opposite plus/minus phase to that of the straight line L1, is drawn. Then, a distance d from the origin to an intersection O between the straight lines L1 and L2 is estimated as-the maximum matching position in the leftward-rightward direction/upward-downward direction.

FIG. 13 shows the xy coordinate graph when m(−1)>m(1) holds. The distance d of the estimated maximum matching position at this time is given by

d={m(1)−m(−1)}/2{m(0)−m(1)}.

When m(−1)<m(1) holds, the xy coordinate graph is as shown in FIG. 14. The distance d of the estimated maximum matching position at this time is given by

d={m(1)−m(−1)}/2{m(0)−m(−1)}.

As described above, as a position estimated at the maximum matching level is determined as a maximum matching position using a high matching level position, the matching levels in the position and its peripheral (in leftward and rightward directions/upward and downward directions) positions, even when a matching position does not exist in pixel units, the distance d from the origin to a matching position of the second image (B) to the first image (A) can be obtained by subpixel units 1/s as a unit of dividing one pixel into plural subpixels s.

FIG. 15 is a conceptual diagram showing another processing in the maximum matching position estimation processing. In this processing, a parabola P is used, and the distance d from the origin to a peak value of the parabola P is estimated as a maximum matching position in leftward and rightward directions/upward and downward directions. The distance d of the estimated maximum matching position at this time is given by

d={m(−1)−m(1)}/{2m(−1)−4m(0)+2m(1)}.

When a matching position is estimated and determined by this maximum matching position estimation processing, the expansion size (expansion number) of the additional entry information extraction unit 106 is a decimal number. In the case of a binary image, since a processing after the expansion processing is made in subpixel units, rounding, rounding up or rounding off is required.

The foregoing description of the exemplary embodiments of the present invention has been provided for the purposes of illustration and description. It is not intended to be exhaustive or to limit the invention to the precise forms disclosed obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image processing apparatus comprising:
a first positioning part that performs positioning between a first original image and a second original image which is obtained after execution of additional entry, with respect to an entire original;
a first extraction part that extracts difference information between the first original image and the second original image subjected to the positioning by the first positioning part;
a second positioning part that locally performs positioning between the first original image and the second original image based on the difference information extracted by the first extraction part; and
a second extraction part that extracts additional entry information from the second original image between the first original image and the second original image subjected to the positioning by the second positioning part.

2. The image processing apparatus according to claim 1, further comprising an area division part that performs area division on the first original image and the second original image based on the difference information extracted by the first extraction part,
wherein the second positioning part performs the positioning by area divided by the area division part.

3. The image processing apparatus according to claim 2, further comprising an integration processing part that integrates difference extracted pixels deemed to belong to the same area into an integrated area, based on difference extracted pixels extracted by the first extraction part,
wherein the area division part performs the area division on the first original image and the second original image based on a result of integration processing by the integration processing part.

4. The image processing apparatus according to claim 3, wherein the integration processing part obtains a distance between the difference extracted pixels, and when the distance is equal to or less than a predetermined threshold value, integrates the difference extracted pixels into an integrated area.

5. The image processing apparatus according to claim 3, wherein the integration processing part generates figures in a predetermined size with the difference extracted pixels as centers, and when the figures are overlapped with each other, integrates the pixels into an integrated area.

6. The image processing apparatus according to claim 3, wherein the integration processing part classifies the difference extracted pixels into connected pixel groups then obtains a substantially circumscribed rectangle by connected pixel group, and expands the circumscribed rectangle by a predetermined size, and when the expanded circumscribed rectangles are overlapped with each other, integrates the rectangles into an integrated area.

7. The image processing apparatus according to claim 3, wherein the integration processing part judges connected pixel groups including the difference extracted pixels in the second original image subjected to the positioning by the first positioning part, and integrates the difference extracted pixels belonging to the same connected pixel group into an integrated area.

8. The image processing apparatus according to claim 2, wherein the area division part performs the area division on the first original image based on the area division in the second original image.

9. The image processing apparatus according to claim 2, wherein a size of the area division in the first original image is greater than a size of area division in the second original image, and
the second positioning part moves the divided area in the second original image within the divided area in the first original image thereby obtains a matching point between images of the both divided areas.

10. The image processing apparatus according to claim 2, wherein the size of the area division in the second original image is greater than the size of the area division in the first original image, and
the second positioning part moves the divided area in the first original image within the divided area in the second original image thereby obtains a position at a high matching level between images of the both divided areas.

11. The image processing apparatus according to claim 9, wherein the second positioning part shifts the divided area in the second original image or the first original image in a direction where the matching level is high, and when the matching level in the direction becomes low, determines a position before shift as a matching position.

12. The image processing apparatus according to claim 11, wherein the second positioning part estimates a position at a highest matching level using a position at a high matching level and matching levels in the position and peripheral positions.

13. The image processing apparatus according to claim 1, wherein the first and second extraction parts perform processing to subtract an image, obtained by expanding ON pixels of the first original image, from the second original image, and
a size of expansion of the second extraction part is equal to or smaller than a size of expansion of the first extraction part.

14. A computer readable medium storing a program causing a computer to execute a process for image processing, the process comprising:
performing positioning between a first original image before execution of additional entry and a second original image after the execution of the additional entry, with respect to an entire original;
extracting difference information by comparing the first original image with the second original image subjected to the positioning;
locally performing positioning between the first original image and the second original image based on the extracted difference information; and
extracting additional entry information from the second original image by comparing the first original image with the second original image subjected to the positioning.

15. The image processing apparatus according to claim 10, wherein the second positioning part shifts the divided area in the second original image or the first original image in a direction where the matching level is high, and when the matching level in the direction becomes low, determines a position before shift as a matching position.
